(19) United States
(12) Patent Application Publication
(10) Pub. No.: US 2010/0262475 A1
(43) Pub. Date: Oct. 14, 2010

(54) System and Method of Organizing a Distributed Online Marketplace for Goods and/or Services

(76) Inventors: Alexei Gavriline, North York (CA); Michael State, Richmond Hill (CA)

Correspondence Address: YOUNG BASILE, 3001 WEST BIG BEAVER ROAD, SUITE 624, TROY, MI, 48084, US

(21) Appl. No.: 12/600,962

(22) PCT Filed: May 22, 2008
(86) PCT No.: PCT/CA2008/000973

§ 371 Date: May 14, 2010

Related U.S. Application Data
(60) Provisional application No. 60/939,398, filed on May 22, 2007.

(51) Int. Cl. G06Q 30/00; G06Q 20/00; G06Q 10/00; G06Q 50/00; G06F 3/048

(52) U.S. Cl. 705/14.13; 705/14.23; 715/856

(57) ABSTRACT

Disclosed are methods and systems for organizing and growing an online or otherwise dynamically accessible distributed marketplace for goods and services offered either at a particular location, or at a particular time, or available in certain quantity, or exhibiting some or all of the above characteristics. One such system comprises means for posting in real-time vendor offers to an online database based on the at least one parameter, means for identifying a location of a consumer based on a consumer action at the host site, means for generating relevant offers based on the consumer action or location, wherein the offers are viewed through the host site, means for accepting the offers by the consumer through the host site, means for processing revenue and means for distributing revenue wherein the database dynamically communicates with a plurality of host sites at any given time and generates relevant offers for a plurality of consumers on the plurality of host sites at any given time.

### BACKGROUND

The present invention generally relates to a system and method of organizing an online marketplace for goods and services offered either at a particular location, or at a particular time, or available in certain quantity, or exhibiting some or all of the above characteristics.

In various markets, merchants and consumers are required to, physically meet in order to transact business (herein called “physical transactions”). There also exists a class or classes of markets where the merchant's ability to deliver goods and services depends on the time where these goods and services are to be delivered (herein called “time specific” transactions). Specific examples of businesses representing this part of the economy may include, but not be limited to: professional services, beauty salons, restaurants, theaters, golf courses, plumbing services, local book stores, apparel stores, convenience stores etc.

Existing approaches to sales on and through Internet and wireless services like cellular devices are focused on offering goods to a vast number of dispersed users.

There are generally two ways the transactions are conducted. The first way involves direct sales from a merchant to a user via the online or otherwise accessible physical store of that merchant. The title to the goods available for sale may belong to the merchant owning the website or as to a third party offering goods to the merchant on consignment basis. The examples of online marketplaces based on such principles are Amazon.com, Sears.com, Expedia.com and many other establishments selling on and through the Internet.

The second way transactions are conducted involves direct sales from a merchant to buyer through a venue that acts as a portal where merchants post their goods and consumers search for the goods of interest. The transactions happen directly between merchant and the consumer and the venue plays no significant role in the transaction other than collecting fees from merchants for enabling their business. The most known example of such a venue is Ebay.com. In both models, shipment of product to the purchaser is a generally accepted component of the transaction.

The common practice of shipping goods to customers does not apply to local service economies where the customer and a vendor have to either physically meet in order to transact or vendor performs the actual delivery of the goods and/or services. Delivery and/or transaction completion in such situations depends on the vendor's schedule, time of operations, order load, etc. Currently there is no solution that adequately addresses the problem.

Further, the above methods are not effective for local economies as they fail to match vendors and users based on principles of location- and time-relevance as well as address the issue of varying business load and available supply at any given time. Most search engines or venues through which vendors and consumers attempt to engage in commercial and non-commercial transactions are worldwide in scope, and usually provide the user with information from around the globe. However, when the user seeks goods and services available within certain proximity of the user's geographic location, a search becomes more difficult and, in many cases, results in displaying just the names and addresses of local establishments.

To attract customers, local establishments must resort to devices such as coupons and other incentives that normally are not narrowly time- and quantity-relevant. These traditional promotional methods are inherently risky as they limit merchants' ability to dynamically affect demand at any given moment in time and efficiently match it with available supply. This, in turn, may result in less attractive offers available to consumers. Therefore finding an attractive offer of interest within a certain proximity and on a particular date becomes a challenge to the consumer.

Furthermore, there are serious cost constrains preventing small and medium size business from conducting business online. It is often cost prohibitive for a local company with one or two offices to conduct a key-words online campaign. To be successful on the Internet, a business needs to establish presence on many various portals and websites where consumers look for information on specific product and services. Establishing and managing relationships with these portals and websites may be cost- and time-prohibitive to coordinate an online campaign across the web. There is currently no solution that would address the above problem and offer an efficient tool for managing online, real-time, dynamic, location-specific advertising and promotional campaigns across the internet from a single interface for local merchants.

### SUMMARY

Disclosed herein are methods for organizing a dynamically accessible distributed marketplace and/or services offered under at least one defined limiting parameter. One such method comprises assembling a database comprising real-time offers posted by the vendors based on the at least one limiting parameter. In response to an action by the consumer on a host site, at least one real-time offer from at least one vendor is displayed on the host site from the database for the goods and/or services based on the consumer action. In response to an acceptance by the consumer, associations are created between the host site and consumer within the marketplace. A user profile is created and associations created between users. Proceeds are distributed in accordance with a set of pre-determined organizational rules and the associations. The database dynamically communicates with a plurality of host sites at any given time and generates relevant offers for a plurality of consumers on the plurality of host sites at any given time

Another disclosed method for organizing a dynamically accessible distributed marketplace and/or services offered under at least one defined limiting parameter comprises a vendor identifying a good and/or a service, associating the good and/or service based on the at least one limiting parameter with a database comprised of organizational roles and principals associated with a compatible marketplace segment, attributing at least one reward to participants in said compatible marketplace segment, and notifying participants of the availability of said good or service in response to a predefined event.

Also disclosed herein are systems for executing a dynamically distributed marketplace. One embodiment of a system comprises at least one web server, the web server hosting at least one portal accessible to at least one client-based application or device, a database containing information on marketplace consumers, a database of commercial and/or non-commercial offerings, and means for participants to update commercial and non-commercial offerings in the database and to transact offerings.

Another embodiment of an online system for organizing a dynamic marketplace for goods and/or services offered under at least one limiting parameter comprises means for posting in real-time vendor offers to an online database based on the at least one parameter, means for generating relevant offers on the host site based on the consumer action or location, wherein the offers are viewed through the host site, means for accepting the offers by the consumer through the host site, means for processing revenue and means for distributing revenue.

### DETAILED DESCRIPTION

The disclosed systems and methods create and maintain an online venue through which physical and time-specific transaction vendors can advertise their commercial and non-commercial offers in real-time and dynamically affect the demand for their goods and/or services by managing at least one of the quantity of available offers, the time and location for which these offers are available, as well as price and other parameters of the offers. The basic information and relationship flow diagram is presented as FIG. 1. It is also contemplated that the vendors can provide various incentives for potential customers. The offers may be accessible directly or through various host sites, including but not limited to affiliate and non-affiliate third-party websites, a centralized portal, etc. depending on the particulars of an installation or deployment. The system, as shown in FIG. 2, provides means for a potential customer to review the offer and immediately reserve the offer without leaving the website or other medium where the offer was located by either buying it, and/or booking it, and/or leaving a deposit to be applied towards the offer when the offer is redeemed.

An embodiment of an online system for organizing a dynamic marketplace is schematically shown in FIG. 2. The marketplace provides means 10 for vendors to post, change or delete offers either directly on the online marketplace or through a host site. As used herein, “host site” refers to the marketplace itself, or any other portal or web site of an affiliate or third party. Consumers 20 can enter or log on to a host site 30, wherein the host site is the online marketplace or an affiliate or third party website. Means for identifying a location of a consumer 20 based on a consumer action at the host site 30 provides relevant information about the consumer. The online system further comprises means for generating offers 40 from the database on the host site that are relevant to the consumer 20 based on the location or other action by the consumer at the host site 30. Means for accepting the offer provide the consumer with a mode of acceptance. As a non-limiting example, the consumer can point and click or use a keyboard to accept. Acceptance can be a reservation, a deposit, a purchase, etc. of the offer. The online system has means for processing the revenue 50 generated at the acceptance and means for distributing the revenue. Distributing the revenue 50 can include, as- non-limiting examples, taking a fee, providing a fee or percentage to an affiliate or third party website or to the host site.

The system is an online system operating on the internet. The system operation is described in detail later in the specification. In general, the system is comprised of software and/or hardware that is incorporated into or interfacing with a database.

The system disclosed herein contemplates a database that contains relevant information including but not limited to a user profile. In the systems and methods disclosed herein, each transaction such as a reservation, booking and/or purchase is recorded in the database. The record is linked to the user profile of each party participating in the transaction. The first-time a user enters into a transaction, the system automatically creates this user's profile utilizing information such as email address and other fields. The newly created user profile is automatically linked and related to the profile of an “upstream” user. The “upstream” user is selected based on a set of rules specific for a particular installation and deployment. By the way of example, the “upstream” user may be a publisher of a website on which the new user transacted the first time, a charity, a franchisee who purchased rights for promoting the system in a particular geographic territory and/or any other type of user, person or organization, determined based on various parameters specific for a particular implementation of the system. As used herein, a user is anyone accessing the marketplace through a host site.

Capturing and maintaining information related to each transaction and the relationships between participants of the marketplace allows further complement to the above described method by a set of rules enabling interested marketplace participants to earn commissions and/or fees and/or otherwise benefit from transactions conducted by other participants (their “downstream” participants). Specifically, this allows publishers and other interested parties to monetize their user base via earning commissions, and/or fees, and/or otherwise benefit from transactions and/or other activities of their “downstream” users conducted on various other venues associated with the said online marketplace.

The method disclosed herein can be further complemented by a method of organizing and presenting information about available offers to an interested user, such as dynamically created listings of relevant offers based on the user's profile and preferences; and/or based on individual details of the offer including time, category, venue and key words; and/or based on geographic proximity of the venues where the offers can be redeemed to the location of the user. The system may be further advanced by providing means for displaying offers based on other rules programmed in the internal rule engine embedded in the system.

The revenue generating system supports various business arrangements and methods. The revenue generation system acts as a clearing house for all the transactions conducted between the users of the system. The system transacts with the purchasing participant on behalf of the selling participant and the proceeds are credited to the account of the selling participant net any fees and commissions. This does not exclude the situation when the collected amount equals fees and commissions and as such are withheld in its entirety. In this case, the fees and commissions can be interpreted as a referral fee for sending a qualified customer to a vendor. The above doesn't preclude the use of the system for reservation purposes whereby no money changes hands at the moment of reservation. Further, system usage fees may be charged for any commercial use of the system on a pay-per-use basis or subscription fees may be charged to use the system for a defined period of time. The above does not preclude implementations where participants use the system for free based on suitably defined selected criteria, which may include, but are not limited to, publicizing community events and offers, publicizing charitable and volunteer activities, and reserving non-commercial offers.

As was discussed above, the described system establishes and traces relationships between participants of the marketplace based on the set of rules chosen for a particular implementation of the system. As such, the system may be configured to trace the relationships between participants, based on suitable criteria, nonlimiting examples of which include factors such as who invited whom, and/or on the basis of a geographic region where participants are located, and/or based on a category of an offer and/or other criteria (“upstream” and “downstream”-relationships) and as such is configured to support and enable various franchise and multi-level marketing/sales business models. As possible revenue generating models, marketers and entrepreneurs may be charged fees for having access to the system and an opportunity to promote it to various potential users, possibly within specified territories or for a specific type of goods or service. In exchange for these fees, the marketers would be rewarded for each transaction resulting from their activities as well as collecting part of the fees collected from new paying participants they attract to utilize the system.

The flexibility of the system allows revenues to be generated through any combination of the named system usage fees, subscription fees commissions deducted from the proceeds from the sales of merchants' offers, from referral fees, and/or from various usage and subscription fees collected from the vendors and marketers using the system.

Disclosed herein is a methodology that comprises a set of methods and a system for organizing and growing an online or otherwise dynamically accessible marketplace for goods and services offered either at a particular location, or at a particular time, or available in certain quantity, or exhibiting some or all of the above characteristics. The method and system disclosed addresses needs of the markets where vendors and consumers are required to physically meet in order to transact and/or where the vendor's ability to deliver goods and services depends on the time where these goods and services are to be delivered.
1. The various components are:
   (a) a centralized database containing, among other things, information on participating vendors, their offers, other relevant vendor-related information, information on consumers, information on affiliates, information of relationships between all the participants as well as other information.
   (b) means for affiliate websites and other interested third-parties to dynamically access the database, dynamically display available offers and enable transactions for said offers.
   (c) means for affiliate websites and other interested third parties to enable merchants to access database, design and submit offers to database in real-time.
   (d) means for automatically capturing and processing data for each transaction, creating associations between participants and distributing the proceeds in accordance with multiple sets of rules and arrangements
   (e) time- and location-relevant search capacity configured to permit each user to see information relevant to the user's location, interests and time window;
   (f) services-oriented e-commerce, ticketing, reservation and reporting engines so that users comfortably transact online;
   (g) content creation tools where the content is generated and managed by the users in real-time so that they can turn the volume of business up or down; and
   (h) network effect built into the model.

FIG. 3 is a diagram of a methodology disclosed herein. Vendors can post offers, change offers, and delete offers from the marketplace either directly or through a chosen affiliate or third party site (110). Consumers can enter or log on to a host site 120. The consumer can provide user information or simply provide a parameter such as location. Offers from the marketplace are displayed on the host site based on the consumer input 130. The consumer can accept the offer, which can mean reserving, depositing, purchasing, etc. the offer 140. If the consumer is a first time user, a user profile is created 150. Associations are made between users, including but not limited to between consumer and vendor, vendor and vendor, and consumer and consumer. The marketplace distributes proceeds from the offer based on a predetermined set of organizational rules and the associations 160. The set of rules applied can be dependent on the particular vendor, consumer, host site, affiliate, etc. The steps are accomplished using a computer program comprised of software and hardware that is incorporated into or interfaces with the database.

A feature of the disclosure is that the market place is designed to be easily distributed. The user can transact on any affiliate website or other media host site maintained by various third parties participating in the system, without actually leaving that site or medium.

Similarly, a vendor can access the marketplace and post offers through interfaces directly available from an affiliate website or other media maintained by third parties with which said merchant has commercial or other relationships and/or through a centralized portal.

From a consumer perspective, the system can be viewed as a distributed online hub for real-time information on locally available offers. The user searches for goods and services through various search engines or on third parties' websites and other media the user is accustomed to utilizing. FIG. 4 is an example of a screen viewed by the consumer. The consumer enters a host site 210 on the internet 205 and enters a search 220. The results 230 are displayed on the host site 210. If there is an offer 250 from a vendor for one or more of the results 230, the offer 250 will be flagged 240. Other offers 250 that are relevant to the consumer but not directly related to the search can be posted as advertising or other additional information on the host site 210. The information on available offers is available from the search results or is linked to the information on the websites and media based on various logic that fits the business model and purpose of the given websites and media. Thus, the information on available offers may be displayed on the paid advertising banners of a particular merchant, show on directory listings next to or within space allocated to a particular merchant, within search results that contain information on a particular merchant, be content dependent and appear in reviews of merchant's goods and services, in articles that mention merchant's name or other relevant information as well as in many other ways that best fit the purpose and business model of said affiliate websites and third parties' media. The information can be further organized in a way that each user sees only those offers that match user's interest, are available around the user's specific location, and are offered during the time window that suits the user, etc.

The system makes it easy to find various pieces of information users may want to review in order to make an intelligent buying or reservation decision.

From the vendor perspective, the system can be viewed as a vehicle to deliver targeted messages to a highly receptive audience ready to immediately act on their buying decisions. As a distributed market place, the system ensures that vendors' offerings are easily managed through a single interface and instantaneously synchronized across all affiliate websites and other third party media. This greatly reduces the cost of managing online campaigns and ensures their efficiency.

The method and system disclosed herein can be based on any suitable pricing model. These include, but are not limited to, the pay-per-sale pricing model, usage fees model and/or subscription model. To enable pay-per-sale pricing model, the system withdraws a commission from the proceeds merchants collect for their offerings online. Further, the pay-per-sale model can be implemented in various ways. While some merchants (such as theaters) may opt for collecting the whole amount from the customers upfront, many merchants may decide to collect only a deposit necessary to cover the system usage fees. In such situations, to take advantage of an offer, a user would be required to put down a deposit towards the deal. The deposit typically would equal the system usage fees and is retained by the system. When the user claims the offer, the amount of the deposit can be applied towards the total bill and therefore represents a referral fee from the point of view of a merchant. As it can be seen, the above described method ensures that the vendor pays commissions (referral fees) only when the qualified customer actually redeems the offer and the sale is completed.

In some cases, the user may be able to reserve the vendor's offers without paying any money upfront. In such instances, the merchant will be charged either a usage fee for each reservation or a subscription fee billed on a periodic basis and allowing for a defined usage of the system during subscribed period. These models can be complemented by restricting the usage level covered by the subscription fee, and charging said merchant an additional usage fee for extensive use of the system in excess of that covered by the subscription fee. Furthermore, the pay-per-use, system usage fee, subscription fee and other possible revenue generating models can be combined in a single implementation of the system.

The “upstream/downstream” associations between participants of the marketplace (the users of the system) allow for providing various incentives and implementing revenue-sharing models with various affiliates whereby these affiliates are reimbursed for their efforts and activities.

Specifically, the method allows publishers to secure residual revenue streams from their readership. As long as a user is associated with the publisher as a “downstream” user, the publisher may be rewarded for each transaction to which this user is a part, regardless where this transaction takes place.

The system includes means for substantially automated real-time creation and posting of offers in a predefined format and tools that enable merchants to dynamically manage the inventory of posted offers, modify, add or remove the offers in real time.

Users post their offers in predefined format that allows for systematization of posted information and for storing it in the database. This systemized data may be dynamically updated by users of the system in real-time or by internal database management tools.

The system and method disclosed herein further comprises a method for connecting consumers and merchants based on proximity of their geographic locations via maintaining an online marketplace powered by a system comprised of a server and auxiliary hardware that allows for constant maintenance of the database of the offers and dynamic creation of offers delivered to each unique user and customized based on proximity of each event to the user, time window convenient and/or of interest to the user, and other criteria such as the default or user-defined preferences of the user, categories of offers and other criteria as may be defined by the user or the system.

The system further includes a database that contains user profiles of each participant of the marketplace as well as information on the relationships between users (“upstream” and “downstream” relationships).

It is contemplated that each transaction is recorded in the database and linked to the user profiles of each transacting party. The first-time user enters into a transaction, their profile is automatically created. The users of the system may at any time update their profiles and complement them with the information on their preferences, interests, status, preferred pre-defined locations and other information.

The system contains the means for organizing and presenting information about offers to an interested user as dynamically created listing of relevant offers based on the geographic proximity of the venue where the offer can be redeemed to the location of the user. The system may be further advanced by providing means for displaying offers based on the preferences defined by the interested user and/or based on the internal rule engine embedded in the system.

When the user interacts with the system the system may determine location of the user either via IP address, or via cell ID or similar technology (when connection is established from a wireless device), or retrieves a particular location from a list of locations pre-defined by the user. This allows the system to present the user with the dynamically created real-time listing of local offers sorted in accordance with proximity to the user, time window and based on the user and system preferences and criteria.

The system encompasses a basic search engine that allows the user to refine the listing based on particular criteria such as price of the offer, driving distance, discount offered, time the offer is available, etc.

The system is comprised of means that enable propagation of the information posted on the system through various information channels managed by third parties. The interested third party may use simple tools to enable relevant offers to appear on the third-party's website or other interactive venue. The system is further comprised of means enabling remote management of the inventory of offers through interfaces available from websites and other interactive media of said third parties.

The system may be complemented by agent software that analyzes content of a website visited by a user and searches for content relevant offers available through the system that match the user's preferences.

The system offers a user an ability to reserve an offer of choice. The reservation can be either free or may require the user to pay a certain deposit (up to 100% of the price) towards the offer. Upon the transaction the system automatically notifies the user and the vendor of a transaction and issues a reservation receipt (an e-ticket) to the user to be presented to the vendor at the time the offer is redeemed.

The information on each transaction can be stored in the database which can be queried by merchants and users and the transactions records, history and accounts statements can be accessed. Further the system includes and accounting module. Each user is associated with an account maintained within said accounting system. All commissions and proceeds for sales of the offerings through the system are credited to said accounts.

The ability to post offering on the system can be restricted to registered participants of the marketplace who log into the system such as by using ID and password.

The proceeds from the purchase of the offering are collected by the system via payment processing module that enables credit card and other types of transactions. The system is also capable of offering members the ability to utilize funds currently available on their accounts toward purchases made on the system.

A predefined set of rules specific to a particular implementation of the system can be utilized to calculate what percentages of the proceeds from the transaction are due to other participants identified as “upstream” in relation to the transacting participants. These percentages are credited to the accounts of said “upstream” participants. Similarly, a certain percentage of the proceeds may be also credited back to the account of the purchasing member.

It is contemplated that the transaction can be completed through third-party websites or interactive venues hosted by affiliate third-parties, in which case the affiliate third-party receives a share of revenue generated from this particular transaction, in addition to commissions due through associations. The remaining funds, if any, are credited to the account of the participant who posted the offering.

The system can further comprise means for transferring funds from users' accounts held with the system to their bank accounts. The rule engine regulates the process of withdrawing funds from the system. The rules may define such parameters as the minimum amount to be withdrawn from the user's account free of charge, frequency of withdrawals and other principles upon which rule engine operates. The system is further capable of substantially automated transfer of proceeds and commissions to users' bank accounts. Such transfer may be initiated either by a merchant or occur automatically when certain predefined criteria are met. The transaction database is complimented by an accounting module that allows for recording credit and debit transactions and calculates fees and commissions. The information on each transaction is stored in the database which can be queried by users and the transactions records, history and accounts statements can be accessed.

The revenue generating system can act as clearing house for all the transactions conducted between the users of the system. The system transacts with the purchasing user of behalf of the selling user and the proceeds are credited to the account of selling user net of fees and commissions. This does not exclude the situation when the collected amount equals fees and commissions and as such is withheld in its entirety. In this case, the fees and commissions can be interpreted as a referral fee for sending a qualified customer to a vendor. Further, various fees can be charged for any commercial use of the system.

The revenue is generated through collecting system usage fees and commissions from proceeds of sales of offerings as well from other fees charged to users for using certain services offered by the system.

Several objects and advantages of the presented invention are: To provide a method for organizing and growing an online or otherwise dynamically accessible distributed marketplace for goods and services offered either at a particular location, or at a particular time, or available in certain quantity, or exhibiting some or all of the above characteristics, The present invention achieves this object by defining the organizing principles of such a marketplace. Consumers and merchants are matched based on proximity of their geographic locations, time and interests of both parties. The physical delivery of goods and services may happen at a particular location agreed upon by transacting participants. The present invention employs databases designed so that information is centered on time, quantity and location. Deployed algorithms and rule engines allow for dynamically creating a list of offers based on proximity to the user and other criteria and preferences as may be set by the user or otherwise.

To provide a system that serves as a market place where users can post offers and purchase access to posted offers. The present method is based on creating such a system which is used as a marketplace where vendors post their offers and which transacts with users on behalf of posting vendors. The offers represent rights right to receive a certain quantity of goods and/or services from a particular vendor at a set location and at particular time. Since revenue is primarily generated from system usage fees and/or commissions charged only on the sold offerings, the barriers to join the system are very low and vendors have incentives to post their offers on the system.

To utilize the global nature of the Internet and achieve economies of scale while facilitating transactions between participants in small local markets. The method and the system create a single market place where merchants from different locations can reach customers from their locale. While the system is global, the listings it generates are local. This is why while achieving its objective of connecting local vendors with local consumers the method and the system allow for economies of scale not achievable in a small scale local operation.

To provide a substantially automated system for posting and managing inventory of offers, collecting and recording transaction information. Through predefining the format of any posting and allowing users to access databases through a series of simplified dialogues, the system achieves this object.

To enable merchants conduct an online advertising and promotion campaign through multiple venues at the same time enabling them to dynamically manage said campaign through a single interface. The invention achieves this objective by (a) providing technology that allows instant propagation of relevant information to multiple affiliate and non-affiliate information venues frequented by the target audience; (b) providing technology that allows real-time management of the inventory of currently available offers and adjusting campaign based on real-time market and other conditions through a single point of interface and immediately synchronizing information across multiple affiliate and non-affiliate information venues; (c) aligning interests of all the parties so that each party benefits from using the system.

To provide a system that is substantially automated, not restricted to a particular medium and more user-friendly and easy to operate than conventional internet-based systems. Through its modular design the system allows reaching users through various media. Apart from the Internet, the event listings can be delivered to cell phones, PDAs, kiosks, sales terminals and other devices. The user-friendliness is achieved through predefining formats and automating queries via interview-like scripts.

To provide a system where the listings are automatically updated in real-time based on offer expiration, depletion of the inventory, and/or changes introduced by merchants. The system is designed so that the listings are created dynamically and in real time. Therefore expired inventory and/or sold-out offers may be explicitly omitted from the list unless user explicitly instructs system to show expired or sold-out offers. All the latest changes are reflected in the listing as it is build dynamically and in real-time. All the changes are immediately propagated to all third-parties' information venues.

To provide a method for organizing and growing an online community intended as a venue for facilitation business transactions between members. The present invention provides set of principles that allow for organizing the said community and facilitate natural growth of the community as each member can be financially rewarded for contributing to the growth of the said community.

To enable publishers to earn recurring revenue from their audiences in addition to earning advertising revenues from parties interested to reach said audiences. The present invention provides for automatic association between a publisher and a user and rewards the publisher for any activity of the user on the marketplace for a set period of time. Furthermore, the present invention enables publishers to earn transactional revenues in addition to the advertising revenues.

To create a ‘low risk’-‘high reward’ business method that ensures active user participation. The invention achieves this objective by virtually eliminating all the risks for participants by enabling pay-per-action pricing model as one of the available revenue generating models. Thus, if pay-per-action model is implemented, by posting an offer a vendor ensures exposure to a qualified audience, while paying only a small “referral” fee for each qualified customer and only when the customer actually transacts with the vendor. The customer bares no risks as the money deposited on the system is applied towards the offer at the moment the customer redeems the offer.

To provide a flexible revenue generating system based on the named methods. The present invention details all the necessary components of such revenue generating system and provides for continuous and growing revenue stream generated from exploiting named system.

The revenue generating capacity of the system follows from the business method, particular implementation and a chosen business model. Various business models as well as their combinations may be enabled on the system.

While the method and system disclosed herein can be embodied in many different forms, there will be described below in detail, specific embodiments with the understanding that the embodiments are to be considered to be an exemplification of the principles of the invention, and the embodiments are not intended to limit the invention to the embodiments illustrated.

The below description relates to a contemplated embodiment.

For the purposes of this disclosure, a user or consumer may be a guest to the site, a site member or just any user viewing a third-party internet page or accessing a third-party information venue. A member has an account with the marketplace site, and a vendor or merchant is a member who places offerings for users to view and/or consume/purchase.

As is well understood by those skilled in the arts related to internetworking, the Internet is composed of a series of routers, each interconnected via data transfer backbone(s). Each router may serve as a gateway to one or more end devices such as Personal Computers, Servers, Wireless Devices (e.g. Cellular Telephone, PDA, etc.) which may be connected via a plethora of topologies composed of both hardware and software. The mechanism and means for communications from these “client” devices with foreign devices for the purpose of requesting or transferring information is well understood and documented, and is thus beyond the scope of this disclosure. This includes discussion of web browsers, DNS servers, web servers, web application servers, database servers, Domain Name Servers, email servers, Short Message Service Centers, hubs, switches, routers, and other internetworking equipment, protocols for communication (like HTTP, HTTPS, TLS, XML, SSL, AJAX, REST, CDMA, GSM, 1XRTT, GPRS), and the like.

The system as disclosed herein can house its data in a database as well as in flat files. This information is stored on the database, web application, and web servers as well as on shared storage servers, proxy servers and in various information caches. For the purposes of illustration, data posted by a merchant about a specific offering is stored within a database, while images related to this same offering are stored on a shared storage server. Some information is also transiently stored in the memory of the web server, web application server and web proxy servers, and client devices involved in an information transfer such as the creation of an offering by a merchant, the subsequent search for offerings by members or guests and the offering purchase and confirmation delivery of these offerings.

Each user who connects to the marketplace directly or through a host site has their location determined by either a location determination technology (like IP address to position, or Cell ID) or by specifying their location either ex-ante (by address, city, zip/postal code, or other positional information), or during the course of the usage of the site using similar location specification mechanisms. The user's known location is used to provide the user with offerings within a specified proximity of their location.

Each member's ID is associated with the set of member's preferences stored in a database. Each member has a member profile.

The system encompasses a module that identifies offers within set proximity to the user's location and populates the listing based on the proximity and/or the offers to the user's current location as well as other user-defined (if the user is a member) or default criteria. The identified events are further organized in a listing which then is delivered to the user.

The listing is viewable and accessible via various interfaces including a web browser and a cellular device (with embedded web browser or J2ME client application). To optimize bandwidth and access speed, users arriving at the site are presented with either listings including pictures or simple text listings according to the client application they are using. Each listing presented contains one or more of the offer title, start and end date/time, time to expiry, pricing, map of location, address of location, driving directions to location, quantity available, terms and conditions, host information, comments about the host, the host's rating, venue information, image, links and other similar information that describes the offer, venue and/or host.

Without logging into the marketplace server infrastructure, limited access is granted to view and search for publicly available offerings in the specified locations with a given set of criteria including key words, category, distance, venue, pricing, etc.

If a user selects a particular offer, he or she may be presented with more detailed information on the offer, venue and/or the host. When the offer is found on an affiliate venue the offer can be researched and reserved without leaving that affiliate venue. An affiliate may request certain functionality not to be available through the affiliate venue. Thus affiliates may not want competitive offers to be available for review next to the offers of their paying customers.

Everybody can create a full user profile on the system. The full user profile details the user's name, address(es), preferences and other information. Alternatively, an abridged user profile is being automatically created based on the information provided to complete the first transaction. The user's email address is used as an identifier. The system automatically emails the user a temporary password and instructions on how to create a full profile. The user, however, is not required to create the full profile as she/he is not required to identify herself or himself to the system before entering into the next transaction. The system will automatically recognize the user as long as the user uses the same email as was used previously.

To create and post offers on the marketplace a user needs to have a full profile on the system and must log-in. The users wishing to post commercial offers must further apply for a marketplace Merchant Account and provide specific details of their identity, whether the account is associated with an organization or businesses. The marketplace system validates each Merchants identity using online and other mechanisms.

To create an offer a user shall follow a procedure implemented as a step-by-step interview. The user can review and modify the offer before making it available online. As soon as the user publishes the offer, it immediately becomes viewable on the internet through marketplace website and affiliate venues. When the offer expires or sells-out, it becomes no longer visible.

The system currently allows creating the various types of commercial offers including, but not limited to:

A monetary discount for spending a set amount of money, i.e. $50 worth of goods for $30.

A percentage discount i.e. 20% on a purchase over $50

X for one deal i.e. buy one entrée and receive the second of equal or lesser value for free.

Fixed amount i.e. enjoy 5 courses meal for $30

Paid promotion i.e. attend free financial seminar.

In addition, any logged-in user can post free time and location-specific offers available in limited or unlimited quantity. E.g. tree planting meeting on Main Street at a particular time.

The offer-creation interviews are optimized for the offer type. Each commercial offer is time and location specific and is available in a limited quantity. All of the offer's parameters are dynamically controlled by the vendor.

In its current implementation, the system deploys “pay-per-action” pricing model. The system automatically defines the system usage fees and commissions to be charged for each completed transaction based on predefined and disclosed set of rules. These fees equal the deposit a user pays in order to reserve the deal. The vendor applies the deposit towards final bill at the time the offer is redeemed. Shall the user not redeem the offer in accordance with agreed upon terms and conditions, the vendor is obligated to honor the deposit at any other time provided the user redeems it at regular prices and meets the minimum purchase requirements specified in the original offer.

The information on all published current events is dynamically distributed to affiliate websites and other venues as well as to search engines so that relevant offers are visible through various affiliate and non affiliate websites and search engines as well as are available through other information channels such as text messages, emails etc.

Furthermore, a marketplace browser plug-in is contemplated. The plug-in would be configured to actively analyze the context of the websites visited by the members and identify content relevant offers available through the user's location, set time window and preferences.

Through an accounting module linked to a database where information on users' transactions is stored users may review their purchases, rate vendors and venues, view their marketplace financial account history, and view other information. The accounting system is complemented by the hold system to control the availability of funds deposited to affiliates' accounts as a result of transactions occurring. The funds for each transaction are released from hold on the fifth day following the redemption of the offer by the customer.

A basic module for tracking and validating transaction is included in the current implementation. Members purchasing/reserving an offer receive a financial transaction number as well as an offer reservation receipt (e-ticket) number which is used to identify the purchaser to the merchant. The e-ticket spells out the nature of the offer, details the deposit collected by marketplace provider and the amount due on the premises where the deal is offered, terms and conditions of the deal and other similar information. Utilizing the facilities of the invention, the purchasing user may view their e-ticket(s), print their e-ticket(s) for specific offers, or alternatively capture and transmit their e-tickets using additional mechanisms like SMS or email.

Merchant users offering deals may identify the list of reserved e-ticket numbers for a particular offer, check which e-tickets are sold at any given time, print the list of e-tickets and validate a particular e-ticket number for their own offerings.

The system also encompasses a module enabling real-time user notification immediately upon the transaction completion. When an offer is purchased/reserved the purchasing user will receive a notification of the order purchase by way of email, SMS, or the like. The offering user may also elect to receive a notification of the purchase via email, SMS, fax, automated telephone message or other similar means of communication. Further the seller may elect to change the communication mechanism for notifications of purchase according to the temporal proximity of the offer's expiry.

In its current implementation the system allows for several potential ways of attracting new users. The users may invite new participants to the marketplace through issuing a personalized email invitation. The users (usually nonprofits and community organizations, newspapers etc) can also invite new participants through a specific web page or open-invitation that allows new participants to sign associates themselves with the inviting user (organization) as “downstream” users. Upon accepting the invitation, new users become linked to the inviting user and become part of this user's downstream community.

In addition to the above described methods of creating upstream/downstream relationships, the affiliates running their own websites or other information venues have access to technological modules enabling them to create “upstream/downstream” association with new users seamlessly while these new users transact through the affiliate website or an information venue.

The disclosed marketplace system utilizes its rules engine for identifying compensation related to the purchase/sale of offerings on the system. This engine allows for the compensation to purchaser (similar to an instant rebate), compensation to the merchant for goods sold, when and if the amount collected exceeds the system fees and commissions, and compensation to the affiliates when the transaction takes place on the affiliate's website or information venue. In addition the engine calculates compensation to the upstream users which the merchant and the purchasers are associated with. The number of calculations carried out varies according to specific arrangements identified with each individual user and specific promotions that may be offered by the marketplace. By way of example, an arrangement with a particular affiliate may be that they receive compensation for those they invited that in turn invited that in turn invited that in turn purchased an offering from the marketplace. In this way, compensation was provided to the user for a purchase that occurred at four degrees of separation from the compensated user. There may be arrangements made to compensate at any given degree of separation. These compensation arrangements may further depend on the details of the offering including its timing, pricing, location, category, venue, the payment method etc.

What is claimed is:

1. An online system for organizing a dynamic marketplace for goods and/or services offered under at least one limiting parameter comprising:
means for posting in real-time vendor offers to an online database based on the at least one parameter;
means for generating relevant offers based on the consumer action or location, wherein the offers are viewed through the host site;
means for accepting the offers by the consumer through the host site;
means for processing revenue; and
means for distributing revenue, wherein the database dynamically communicates with a plurality of host sites at any given time and generates relevant offers for a plurality of consumers on the plurality of host sites at any given time.

2. The system of claim 1, wherein the means for posting is configured to receive dynamic inputted, changed and deleted offers and/or incentives from vendors in real-time to affect demand for the goods and/or services based on the at least one limiting parameter.

3. The system of claim 1, wherein the at least one limiting parameter is selected from the group of a particular location, a particular time, a limited quantity and value considerations.

4. The system of claim 1, wherein the means for processing revenue comprises at least one payment method comprising points, credit card, debit card, Paypal, pre-paid and pre-credited accounts.

5. The system of claim 1, wherein means for distributing revenue is configured for at least one pricing model.

6. The system of claim 1 further comprising means for identifying a location of a consumer based on a consumer action at a host site, wherein the means for identifying comprises one of location determination technology that uses the consumer action or a manual location input.

7. The system of claim 1, wherein the means for generating relevant offers is configured to allow the consumer to narrow the offers viewed based on one or more of key words, categories, preferences, time, price and location.

8. The system of claim 1 further comprising at least one of:
means for tracking relationships between users of the system;
means for developing additional users and tracking development activities;
means for restricting non-registered vendors from posting offers on the database;
means for monitoring offers and acceptances between vendors and consumers and adjusting the means for distributing revenue based on the offers and acceptances monitored;
means for maintaining accounts of each registered vendor and consumer; and
means for pass-word protection.

9. The system of claim 1 further comprising means of notification configured to provide notifications of one or more of select offers, incentives and the consumer's activities on the system via email, SMS, telephone call, fax or other means of communication.

10. The system of claim 1 further comprising means for the consumers to directly contact the vendors and vice versa.

11. The system of claim 1 further comprising a means for communication configured for presenting, querying and transacting via cellular telephones and other wireless equipment, Point-of-Sale equipment, kiosks, and other such equipment.

12. A method for organizing an online dynamic marketplace for goods and/or services offered by vendors to consumers under at least one limiting parameter comprising:
assembling a database comprising real-time offers posted by the vendors based on the at least one limiting parameter;
in response to an action by the consumer within a host site, displaying on the host site at least one real-time offer from at least one vendor from the database based on the consumer action;
creating a user profile once for each consumer and creating associations between profiles based on a set of pre-deed rules; and
distributing proceeds in accordance with the set of pre-determined organizational rules and associations.

13. The method of claim 12, wherein the marketplace is accessible directly, through a centralized portal, or through an affiliate or third-party host.

14. The method of claim 12, wherein the at least one limiting parameter is at least one of a particular location, a particular time, a limited quantity and value considerations.

15. The method of claim 12, wherein displaying the offers comprises the vendors dynamically inputting, changing and removing offers and/or incentives in real-time to affect demand for the goods and/or services based on the at least one limiting parameter.

16. The method of claim 12, wherein the set of pre-determined organizational rules comprises one or more of:
identifying and tracking relationships between the users;
establishing tools for existing users of the marketplace to invite new users;
tracking marketplace development activities;
restricting non-registered users from displaying and/or accessing offers; and
maintaining accounts of each registered user who has once transacted on the system.

17. The method of claim 12, wherein the action by the consumer is at least one of viewing a host site, logging in to a host site, designating a location, designating availability, and designating a preference such that the offers displayed for the consumer are relevant to the consumer.

18. The method of claim 17, wherein the offers are one of manually and automatically matched and bundled based on the action by the consumer or consumer preferences.

19. The method of claim 12, wherein acceptance comprises one or more of viewing, reserving, purchasing, booking and leaving a deposit.

20. The method of claim 12, wherein acceptance is performed by at least one of depressing of a key on a key pad, selecting using a pointing device and selection of a displayed indication.

21. The method of claim 12, wherein distributing proceeds comprises transacting with the consumer on behalf of the vendor of the accepted offer and crediting an account of the vendor net any fees or commissions for one or more of the marketplace or the affiliate or third party website.

22. The method of claim 12, wherein the offers comprise one or more of notification of community events, notification of charitable events, notification of volunteer activities, non-commercial offers, commercial offers, incentives, rewards.

23. The method of claim 12, wherein the online venue further comprises a database comprising user information configured to be retrieved when the user enters the marketplace.

24. The method of claim 12 further comprising dynamically analyzing all the associations created in the marketplace and rewarding the users based on the associations and a predefined set of customizable rules.
